(19) United States
(12) Patent Application Publication
(10) Pub. No.: US 2017/0355088 A1
(43) Pub. Date: Dec. 14, 2017

(54) CUTTING HEAD FOR ELECTRIC HAIR CLIPPERS

(71) Applicant: Soon Sik KIM, Seoul (KR)

(72) Inventor: Soon Sik KIM, Seoul (KR)

(21) Appl. No.: 15/231,107

(22) Filed: Aug. 8, 2016

(30) Foreign Application Priority Data
Jun. 14, 2016 (KR) 10-2016-0073711

(51) Int. Cl. B26B 19/38; B26B 19/06

(52) U.S. Cl. CPC B26B 19/3846; B26B 19/06

(57) ABSTRACT

Disclosed is a cutting head for electric hair clippers capable of providing a smooth and stable haircut and improving processing efficiency and product quality. The cutting head for electric hair clippers includes a fixed cutter, which is secured to a main body of the electric hair clippers and includes a plurality of fixed blades, and a movable cutter, which is configured to perform linear reciprocating movement relative to the fixed cutter using electric power applied to the electric hair clippers and includes a plurality of movable blades. Each of the movable blades has a movable cutting surface maintained in surface contact with a corresponding one of the fixed blades, and a retaining groove formed in the movable cutting surface. The retaining groove in the movable cutting surface constitutes a lubricant-retaining portion and is embodied as a groove engraved inward through a laser etching process.

### BACKGROUND OF THE INVENTION

### Field of the Invention

The present invention relates to a cutting head for electric hair clippers including a fixed cutter, secured to the main body of the electric hair clippers, and a movable cutter, disposed in close contact with the upper surface of the fixed cutter and configured to perform linear reciprocating movement using electric power applied to the electric hair clippers and, more particularly, to a cutting head for electric hair clippers, in which fixed blades of the fixed cutter secured to the main body and movable blades of the movable cutter configured to move reciprocatingly relative to the fixed cutter have retaining grooves formed in contact surfaces therebetween in order to hold injected lubricant for a long period of time, and in which a process of easily forming the retaining grooves in the fixed blades and the movable blades having a relatively small width is provided, thereby leading to stable haircutting performance and improved quality.

### Description of the Related Art

In general, electric hair clippers are configured to cut hair using electric power applied thereto. The electric hair clippers comprise a cutting head, which includes a fixed cutter, which is secured to the main body of the electric hair clippers and includes a plurality of fixed blades, and a movable cutter, which is configured to perform linear reciprocating movement relative to the fixed cutter using electric power applied to the electric hair clippers and includes a plurality of movable blades.

Accordingly, the movable cutter is moved reciprocatingly sideways relative to the fixed cutter, through kinetic energy transferred thereto, in a way such that the movable blades repeatedly approach and move away from the fixed blades. When the movable blades approach the fixed blades, hair is cut.

That is, hair held in the space between the fixed blades of the fixed cutter is cut when the movable blades of the movable cutter repeatedly overlap the fixed blades of the fixed cutter.

The fixed blades and the movable blades have the shape of the teeth of a saw, and are formed in the front tip portions of the fixed cutter and the movable cutter, respectively. Cutting slots are defined between adjacent fixed blades and between adjacent movable blades, into which hair is introduced and held.

The fixed blades of the fixed cutter and the movable blades of the movable cutter are formed to have shapes capable of reliably cutting hair, and to have various geometrical structures, which are determined primarily based on a desired angle of attack relative to hair strands (an opening angle of the tooth-shaped portions) and clipping ability.

At this time, in order to achieve excellent cutting ability, the opening angle of the tooth-shaped portions should be expanded. In this case, the tooth-shaped portions are formed to be sufficiently thin.

Meanwhile, when the movable cutter moves reciprocatingly relative to the fixed cutter while maintaining the state of contact with the fixed cutter as described above, frictional resistance is generated due to friction between the surface of the movable cutter and the surface of the fixed cutter, and consequently frictional heat is generated.

Therefore, lubricant is supplied to the region between the fixed cutter and the movable cutter in order to decrease frictional resistance, thereby providing the smooth reciprocating movement of the movable cutter relative to the fixed cutter.

Korean Utility Model Registration No. 20-0432499 discloses “a structure of a fixed cutter for electric hair clippers”, in which cutting slots of different depths are formed between front tip portions of adjacent blades of the fixed cutter, and the cutting slots of different depths are arranged regularly or irregularly.

Korean Utility Model Registration No. 20-0475543 discloses “improved blades of a fixed cutter for electric hair clippers”, in which cutting slots of two or more different depths are formed between front tip portions of adjacent blades of the fixed cutter and are arranged symmetrically in opposite directions from a central axis of the fixed cutter, and the rear regions of the fixed cutter, which correspond to the respective cutting slots having different depths, are inclined at different angles corresponding to the respective cutting slots having different depths.

Korean Patent Publication No. 10-2010-0005614 discloses a “cutter assembly for hair clippers”, in which fixed blades are formed in the front tip portion of a fixed body of a fixed cutter, which is secured to a support bracket, and movable blades are formed in the front tip portion of a movable body of a movable cutter and are maintained in the state of closely contacting the top surfaces of the fixed blades by a coil spring. Each of cutting slots, which are formed between front tip portions of adjacent fixed blades and between front tip portions of adjacent movable blades, has a larger depth than a conventional cutting slot, for example, in the range from 2.2 mm to 2.8 mm, thereby creating a structure capable of easily guiding hair into the cutting slots and securely holding the hair, and consequently being capable of providing optimal cutting performance with respect to short hair or curly hair.

However, since the above-described conventional cutters for electric hair clippers are not capable of decreasing frictional heat, which is generated between the fixed blades of the fixed cutter and the movable blades of the movable cutter, stable haircutting cannot be achieved.

Further, since it is hard to apply the structure of decreasing frictional force to the contact portions between fixed blades and movable blades in the prior art, cutting performance is deteriorated.

### SUMMARY OF THE INVENTION

The present invention is devised to solve the above problems, and it is an object of the present invention to provide a cutting head for electric hair clippers, in which fixed blades of a fixed cutter secured to a main body and movable blades of a movable cutter configured to move reciprocatingly relative to the fixed cutter have retaining grooves formed in contact surfaces therebetween in order to hold injected lubricant for a long period of time, and in which a process of easily forming the retaining grooves in the fixed blades and the movable blades having a relatively small width is provided, thereby leading to stable haircutting performance and improved quality.

In accordance with an aspect of the present invention, the above and other objects can be accomplished by the provision of a cutting head for electric hair clippers including a fixed cutter, which is secured to a main body of the electric hair clippers and includes a plurality of fixed blades, and a movable cutter, which is configured to perform linear reciprocating movement relative to the fixed cutter using electric power applied to the electric hair clippers and includes a plurality of movable blades, wherein each of the movable blades has a movable cutting surface maintained in surface contact with a corresponding one of the fixed blades, and a retaining groove formed in the movable cutting surface. The retaining groove in the movable cutting surface constitutes a lubricant-retaining portion and is embodied as a groove engraved inward through a laser etching process.

Each of the fixed blades may have a fixed cutting surface maintained in surface contact with a corresponding one of the movable blades, and a retaining groove formed in the fixed cutting surface. The retaining groove in the fixed cutting surface may constitute the lubricant-retaining portion and may be embodied as a groove engraved inward through a laser etching process.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic plan view illustrating the coupling state of a fixed cutter and a movable cutter in a cutting head for electric hair clippers according to an embodiment of the present invention;

FIG. 2 is a schematic plan view illustrating a portion of the coupling state of the fixed cutter and the movable cutter in the cutting head for electric hair clippers according to the embodiment of the present invention;

FIGS. 3 to 6 are schematic plan views illustrating a process of cutting hair using the cutting head for electric hair clippers according to the embodiment of the present invention;

FIG. 7 is a schematic plan view illustrating the movable cutter in the cutting head for electric hair clippers according to the embodiment of the present invention;

FIG. 8 is a schematic enlarged view illustrating a portion of an example of movable blades of the movable cutter in the cutting head for electric hair clippers according to the embodiment of the present invention;

FIGS. 9 and 10 are schematic enlarged views illustrating a portion of other examples of the movable blades of the movable cutter in the cutting head for electric hair clippers according to the embodiment of the present invention;

FIG. 11 is a schematic bottom view illustrating the fixed cutter in the cutting head for electric hair clippers according to the embodiment of the present invention;

FIG. 12 is a schematic enlarged view illustrating a portion of an example of fixed blades of the fixed cutter in the cutting head for electric hair clippers according to the embodiment of the present invention; and

FIGS. 13 and 14 are schematic enlarged views illustrating a portion of other examples of the fixed blades of the fixed cutter in the cutting head for electric hair clippers according to the embodiment of the present invention.

### DETAILED DESCRIPTION OF THE INVENTION

Hereinafter, preferred embodiments of a cutting head for electric hair clippers according to the present invention will be described in detail with reference to the attached drawings.

The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the drawings, the shapes of components are exaggerated for clarity of illustration. In the drawings, the same or similar elements are denoted by the same reference numerals even though they are depicted in different drawings. In the following description, a detailed description of known functions and configurations incorporated herein will be omitted when it may make the subject matter of the present invention rather unclear.

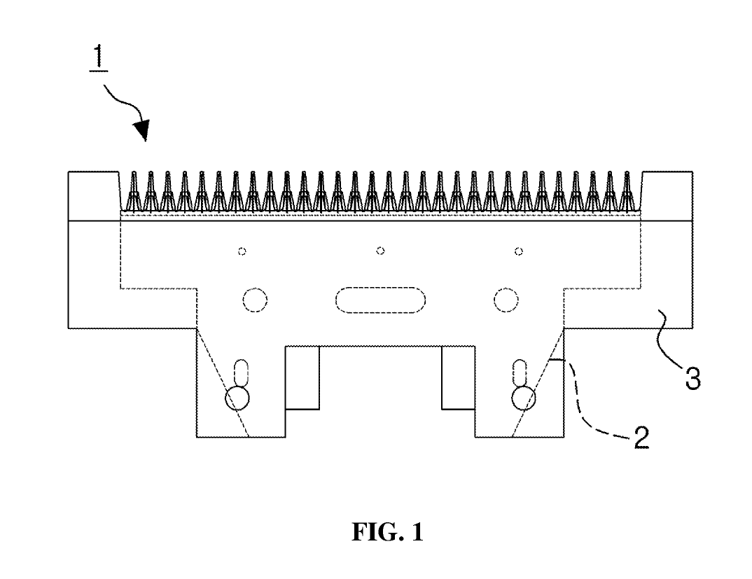

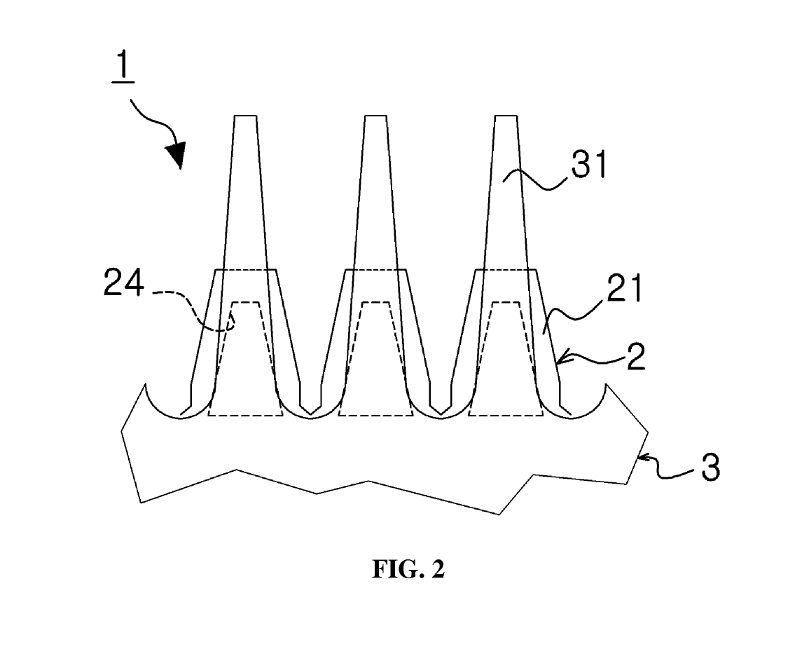

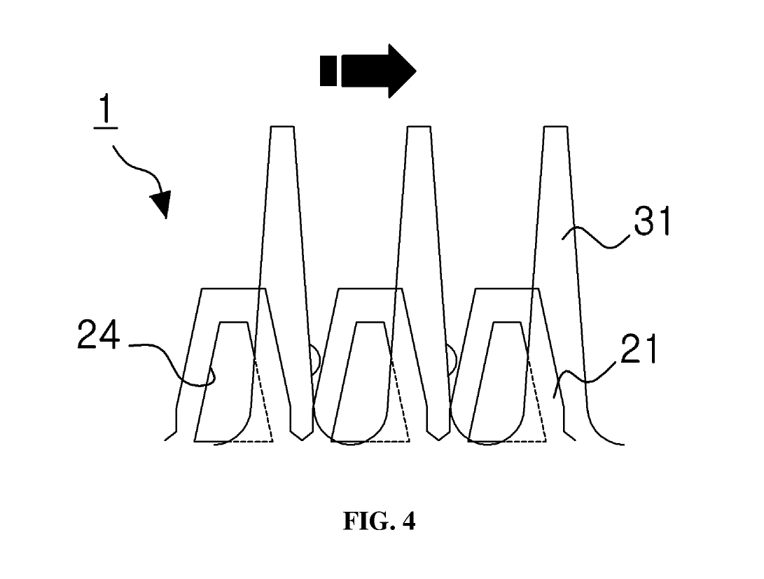

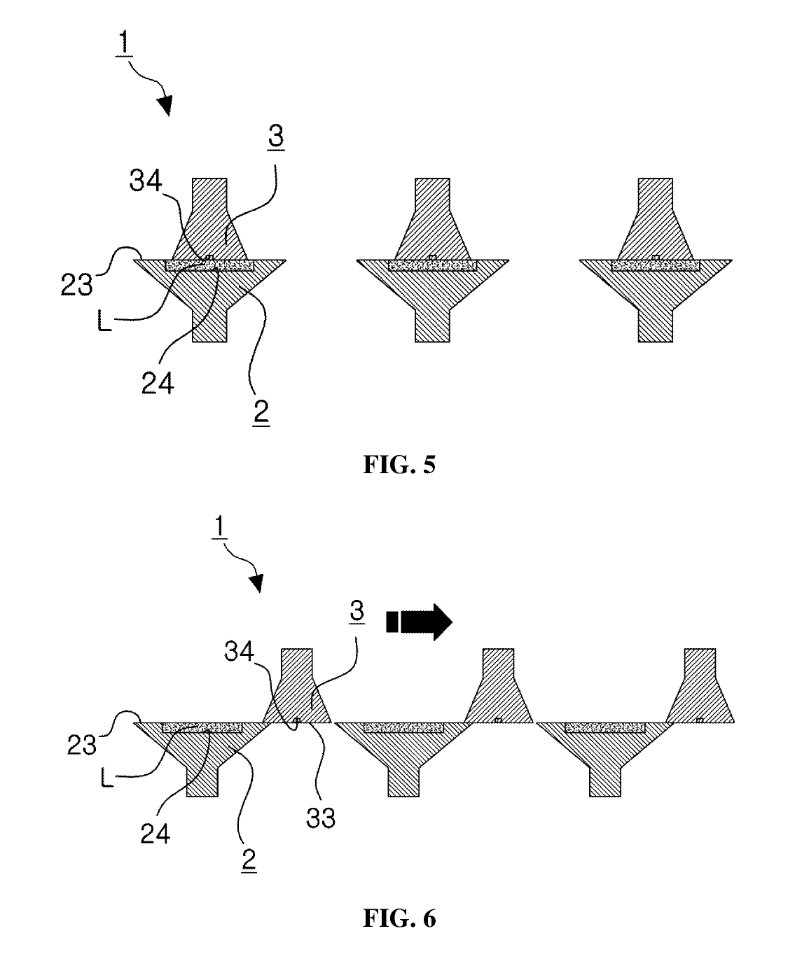

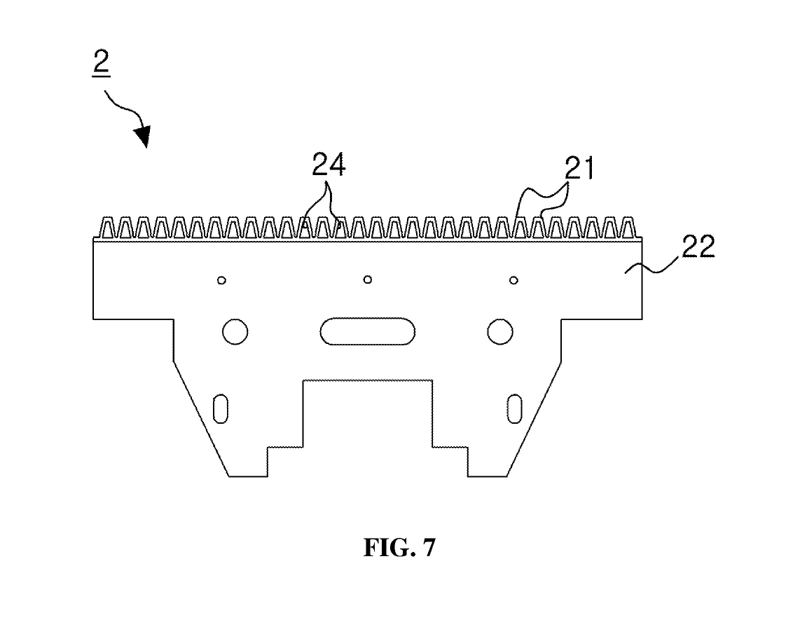

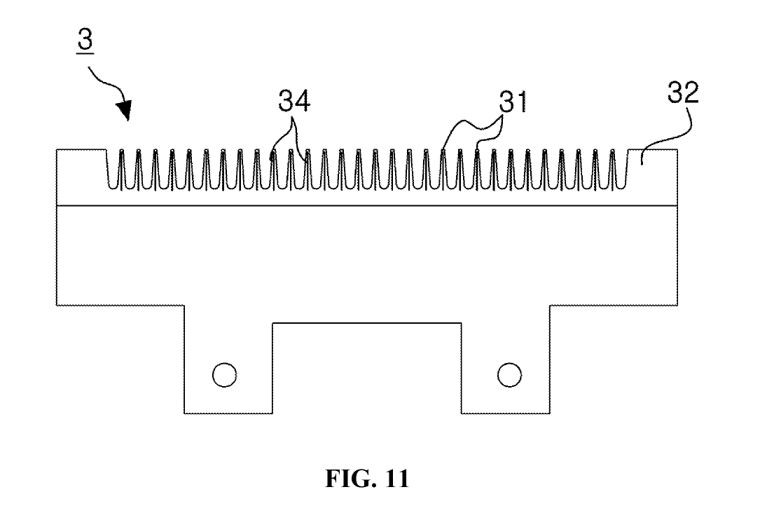

FIGS. 1 to 14 are views illustrating a cutting head for electric hair clippers according to an embodiment of the present invention. A cutting head 1 for electric hair clippers according to the embodiment includes a fixed cutter 3, which is secured to a main body (not illustrated) of the electric hair clippers and includes a plurality of fixed blades 31, and a movable cutter 2, which is configured to perform linear reciprocating movement relative to the fixed cutter 3 using electric power applied to the electric hair clippers and includes a plurality of movable blades 21. Accordingly, hair H is cut by the cooperation of the movable blades 21 with the fixed blades 31.

That is, the movable cutter 2 is moved reciprocatingly sideways relative to the fixed cutter 3 through kinetic energy, generated by the electric power applied to the electric hair clippers, in such a way that the movable blades 21 of the movable cutter 2 repeatedly approach and move away from the fixed blades 31 of the fixed cutter 3. As the movable blades 21 of the movable cutter 2 repeatedly overlap the fixed blades 31 of the fixed cutter 3, hair H held in the space between the fixed blades 31 is cut.

The fixed blades 31 and the movable blades 21 have the shape of the teeth of a saw, and are formed in the front tip portions of the fixed cutter 3 and the movable cutter 2, respectively. Cutting slots are defined between adjacent fixed blades 31 and between adjacent movable blades 21, into which hair H is introduced and held.

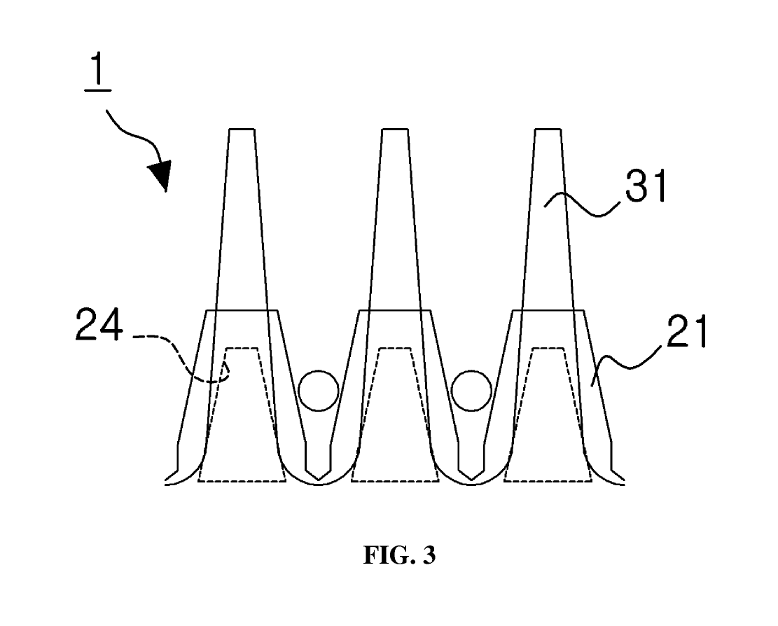

Accordingly, as illustrated in FIGS. 3 to 6, hair H, which is held in the cutting slots, is cut by the overlap between the movable blades 21 of the movable cutter 2 and the fixed blades 31 of the fixed cutter 3.

The fixed cutter 3 includes a fixed body 32, which is formed to have a plate shape, and a plurality of fixed blades 31, which are disposed in the front tip portion of the fixed body 32 and protrude in the manner of the teeth of a saw while being arranged apart from one another to define cutting slots between adjacent ones thereof.

The movable cutter 2 includes a movable body 22, which is formed to have a plate shape, and a plurality of movable blades 31, which are disposed in the front tip portion of the movable body 22 and protrude in the manner of the teeth of a saw while being arranged apart from one another to define cutting slots between adjacent ones thereof.

Preferably, the front tip of each of the fixed blades 31 may protrude further forward than the front tip of each of the movable blades 21, and the lateral width of each of the fixed blades 31 may be smaller than the lateral width of each of the movable blades 21.

In other words, each of the fixed blades 31 is sharper and protrudes further than each of the movable blades 21.

Accordingly, hair H may be securely and stably introduced into the spaces between adjacent fixed blades 31, thereby further facilitating haircutting.

In the cutting head 1 for electric hair clippers according to the embodiment, a first retaining groove 34, which constitutes a lubricant-retaining portion, is formed in a fixed cutting surface 33 of each of the fixed blades 31 of the fixed cutter 3, which is in contact with a corresponding movable blade 21, through an etching process.

It is preferable that the first retaining groove 34 be formed through well-known technology of forming fine grooves, and particularly, the first retaining groove 34 may be formed through chemical etching.

Preferably, the etching process for forming the first retaining groove 34 of the fixed blade 31 may be performed according to well-known technology related to etching. Most preferably, the first retaining groove 34 may be formed to have a “groove” shape, which is engraved inward through a laser etching process.

It is most preferable to apply the laser etching process to the formation of the first retaining groove 34 using well-known technology related to laser etching, and thus a detailed explanation thereof will be omitted.

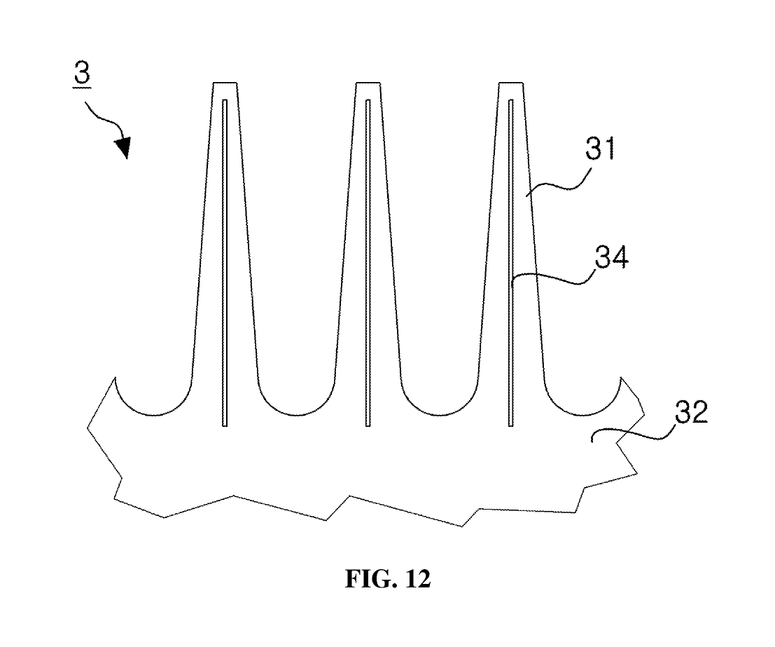

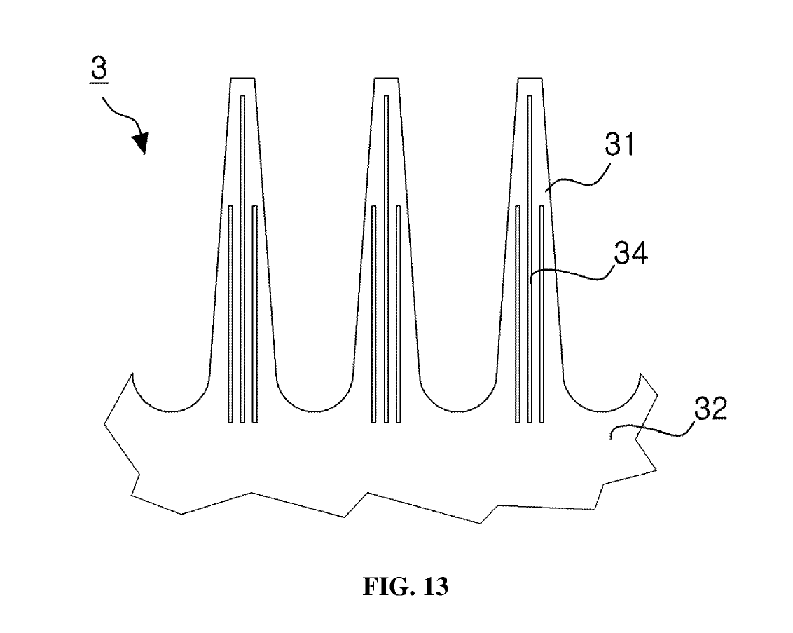

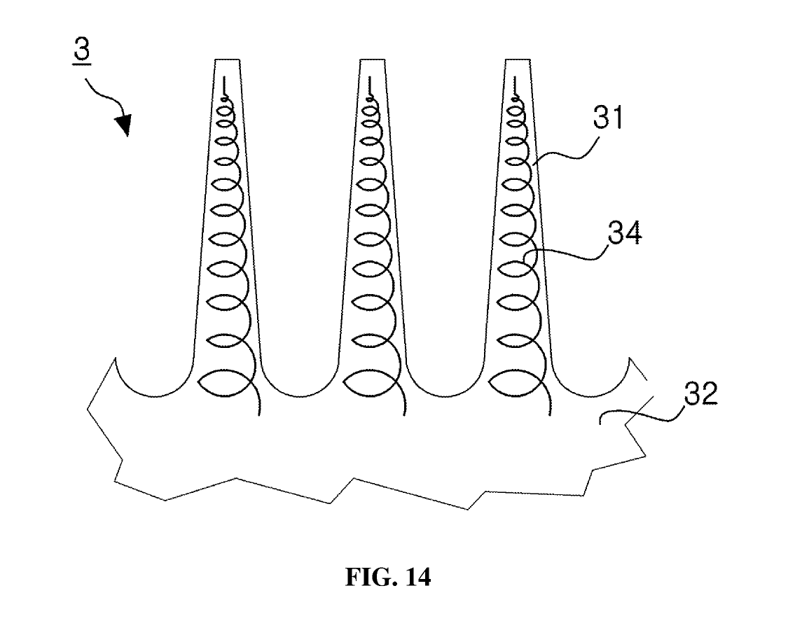

The first retaining groove 34 may be formed to have a straight line shape or a polygonal shape, as illustrated in FIGS. 12 and 13, or to have a curved line shape, as illustrated in FIG. 14, through a laser etching process. A user may select the cutting head having the desired shape of the first retaining groove 34.

In the cutting head 1 for electric hair clippers according to the embodiment, a second retaining groove 24, which constitutes the lubricant-retaining portion, is formed in a movable cutting surface 23 of each of the movable blades 21 of the movable cutter 2, which is in contact with a corresponding fixed blade 31, in a manner such that the second retaining groove 24 is engraved inward through a laser etching process.

Preferably, the second retaining groove 24 may be formed through a well-known laser etching process. It is most preferable to apply the laser etching process to the formation of the second retaining groove 24 using well-known technology related to laser etching, and thus a detailed explanation thereof will be omitted.

Accordingly, it is possible to form the second retaining groove 24 conveniently and stably in each of the movable blades 21 having a relatively small width, which leads to a remarkable decrease in a defect rate and improved processing efficiency.

Further, it is preferable that the second retaining groove 24 be formed to extend in the longitudinal direction of the movable blade 21.

In the cutting head 1 for electric hair clippers according to the embodiment, constituted as above, the contact area between each of the fixed blades 31 of the fixed cutter 3 and a corresponding movable blade 21 of the movable cutter 2 is considerably reduced due to the first retaining groove 34 and the second retaining groove 24.

In addition, lubricant may be securely retained in the first retaining groove 34 and the second retaining groove 24, thereby remarkably decreasing the generation of frictional heat between the fixed blades 31 and the movable blades 21 and consequently providing a smooth and stable haircut.

Described in detail, the lubricant L, supplied to a region between the fixed cutter 3 and the movable cutter 2, is retained in the first retaining groove 34 and the second retaining groove 24. Therefore, when the movable blades 21 move reciprocatingly relative to the fixed blades 31, the lubricant L is not pushed away or lost from the movable blades 21 and the fixed blades 31, and is maintained in the state of being collected in the first retaining groove 34 and the second retaining groove 24 for a long period of time. As a result, lubrication between the movable blades 21 and the fixed blades 31 may be securely achieved.

The operation of the cutting head 1 for electric hair clippers according to the embodiment, constituted as above, will now be described in detail.

The cutting head 1 for electric hair clippers according to the embodiment is coupled to a main body (not illustrated) of the electric hair clippers. When it is intended to cut hair, the movable cutter 2 is moved reciprocatingly sideways relative to the fixed cutter 3 by the kinetic energy that is generated by the electric power applied to the electric hair clippers and that is transferred to the movable cutter 2. As the movable blades 21 of the movable cutter 2 repeatedly overlap the fixed blades 31 of the fixed cutter 3, hair is cut.

At this time, lubricant L is injected to the region between each of the fixed blades 31 and a corresponding movable blade 21, and is collected in the first retaining groove 34 and the second retaining groove 24.

Accordingly, during the reciprocating movement of the movable cutter 2 for haircutting, the lubricant L is not pushed away or lost from the cutters 2 and 3, and performs a lubricating function stably in the state of being retained in the first retaining groove 34 and the second retaining groove 24, thereby providing a stable and safe haircut.

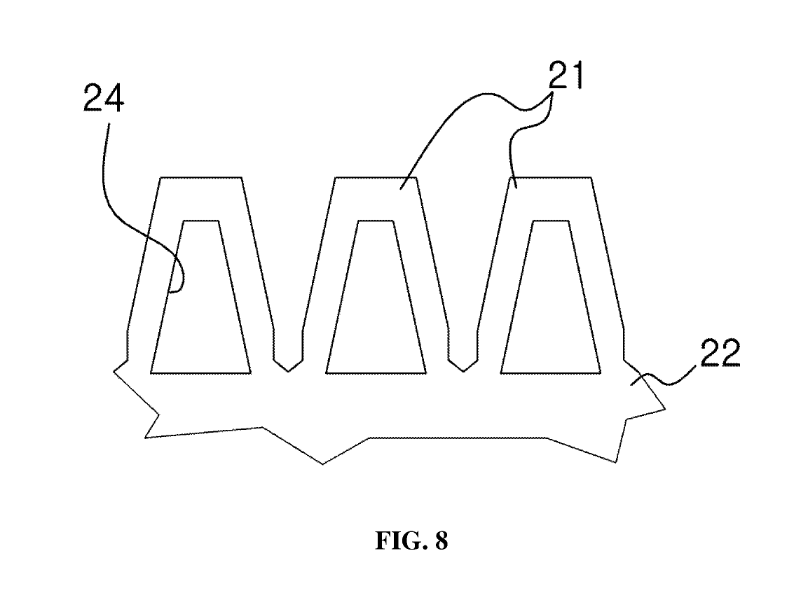

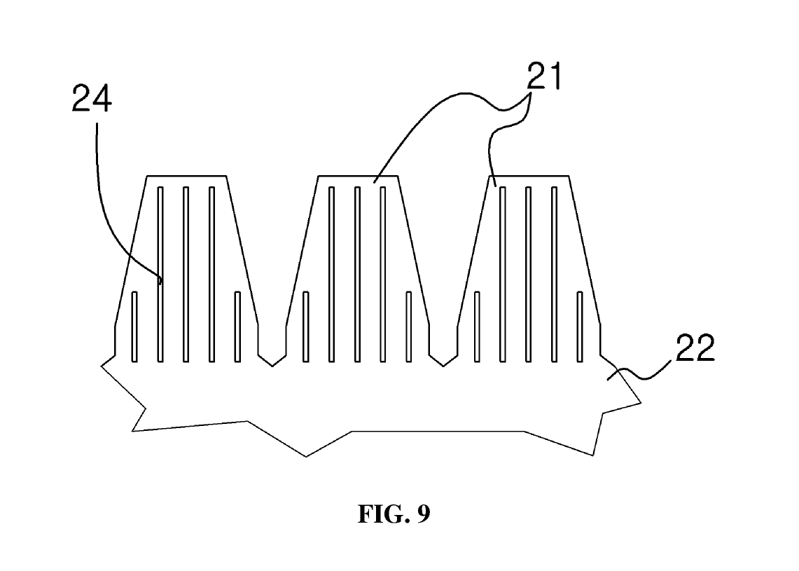

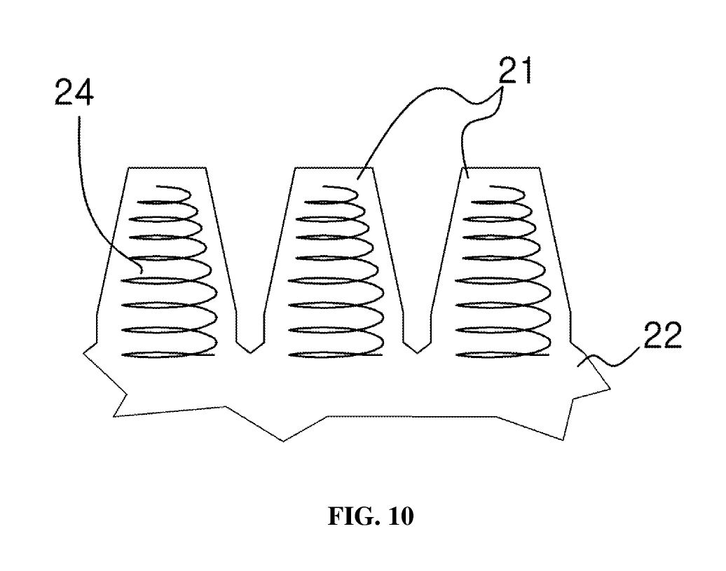

The second retaining groove 24 may be formed in a polygonal shape, as illustrated in FIG. 8, or in the shape of a group of multiple straight lines, as illustrated in FIG. 9, or in a curved line shape, as illustrated in FIG. 10. A user may select the cutting head having the desired shape of the second retaining groove 24.

The curved line shape of the second retaining groove 24 may include, for example, a wave shape or a spiral (or twisted) line shape. In particular, the second retaining groove 24 may be of a spiral line shape, which is formed such that the second retaining groove 24 extends spirally and gradually expands in width from the front tip portion of each of the movable blades 21 toward the movable body 22.

As described above, the second retaining groove 24 having various shapes may be selectively formed in the surface of each of the movable blades 21 having a relatively small width, and a user may select the cutting head having the desired shape of the second retaining groove 24.

Further, the first retaining groove 34 may be formed in a polygonal shape, or in a straight line shape having a predetermined length, as illustrated in FIGS. 12 and 13, or in a curved line shape, as illustrated in FIG. 14. A user may select the cutting head having the desired shape of the first retaining groove 34.

The curved line shape of the first retaining groove 34 may include, for example, a wave shape or a spiral (or twisted) line shape. In particular, the first retaining groove 34 may be of a spiral line shape, which is formed such that the first retaining groove 34 extends spirally and gradually expands in width from the front tip portion of each of the fixed blades 31 toward the fixed body 32.

As described above, the first retaining groove 34 having various shapes may be selectively formed in the surface of each of the fixed blades 31 having a relatively small width, and a user may select the cutting head having the desired shape of the first retaining groove 34.

As is apparent from the above description, the present invention provides a cutting head for electric hair clippers, in which the contact area between each of the fixed blades of the fixed cutter and a corresponding movable blade of the movable cutter is considerably reduced due to the formation of retaining grooves, and in which lubricant is securely retained in the retaining grooves, thereby remarkably decreasing the generation of frictional heat between the fixed blades and the movable blades and consequently providing a smooth and stable haircut.

In addition, it is possible to form the retaining grooves conveniently and stably in the surface of each movable blade having a relatively small width (tiny blade) through a laser etching process, which leads to a remarkable decrease in a defect rate and improved processing efficiency and product quality.

Although an exemplary embodiment of the present invention has been described for illustrative purposes, those skilled in the art will appreciate that various modifications, additions and substitutions are possible, without departing from the scope and spirit of the invention as disclosed in the accompanying claims. Therefore, the embodiment disclosed in the present invention is intended to illustrate the scope of the technical idea of the present invention, and the scope of the present invention is not limited by the embodiment. The scope of the present invention shall be construed on the basis of the accompanying claims, and it shall be construed that all of the technical ideas included within the scope equivalent to the claims belong to the present invention.

What is claimed is:

1. A cutting head for electric hair clippers comprising:
a fixed cutter secured to a main body of the electric hair clippers and including a plurality of fixed blades; and
a movable cutter configured to perform linear reciprocating movement relative to the fixed cutter using electric power applied to the electric hair clippers and including a plurality of movable blades,
wherein each of the movable blades has a movable cutting surface maintained in surface contact with a corresponding one of the fixed blades, and a retaining groove formed in the movable cutting surface, the retaining groove in the movable cutting surface constituting a lubricant-retaining portion and being embodied as a groove engraved inward through a laser etching process.

2. The cutting head for electric hair clippers according to claim 1, wherein each of the fixed blades has a fixed cutting surface maintained in surface contact with a corresponding one of the movable blades, and a retaining groove formed in the fixed cutting surface, the retaining groove in the fixed cutting surface constituting the lubricant-retaining portion and being embodied as a groove engraved inward through a laser etching process.
